(19) United States
(12) Patent Application Publication
(10) Pub. No.: US 2025/0087834 A1
(43) Pub. Date: Mar. 13, 2025

(54) ELECTRODE ASSEMBLY AND RECHARGEABLE BATTERY INCLUDING THE SAME

(71) Applicant: Samsung SDI Co., Ltd., Yongin-si (KR)

(72) Inventors: Kyungho Kim, Yongin-si (KR); Minseung Kang, Yongin-si (KR); Kyeong-yun Park, Yongin-si (KR); Myeongjun Jo, Yongin-si (KR); Eunsong Lee, Yongin-si (KR)

(73) Assignee: Samsung SDI Co., Ltd., Yongin-si (KR)

(21) Appl. No.: 18/824,771

(22) Filed: Sep. 4, 2024

(30) Foreign Application Priority Data
Sep. 7, 2023 (KR) 10-2023-0119188

(51) Int. Cl. H01M 50/46; H01M 50/105

(52) U.S. Cl. CPC H01M 50/461; H01M 50/105

(57) ABSTRACT

An electrode assembly of the present disclosure includes: a first electrode plate and a second electrode plate, each of the first electrode plate and the second electrode plate comprising an electrode current collector and an electrode substrate tab extending externally from a portion of the electrode current collector; a separator interposed between the first electrode plate and the second electrode plate; and a reinforcing member interposed between the separator and an outermost electrode plate disposed at an outermost position of the electrode assembly, the outermost electrode plate being the first electrode plate of the second electrode plate, wherein the reinforcing member is disposed to correspond to an edge portion of the electrode current collector and the electrode substrate tab of the outermost electrode plate.

### CROSS-REFERENCE TO RELATED APPLICATIONS

This present application claims priority to and the benefit under 35 U.S.C. §§ 119 (a)-(d) of Korean Patent Application No. 10-2023-0119188, filed on Sep. 7, 2023, in the Korean Intellectual Property Office, the entire disclosure of which is incorporated herein by reference.

### FIELD

The present disclosure relates to an electrode assembly and a rechargeable battery including the same.

### BACKGROUND

A rechargeable battery is a battery that may be charged and discharged, unlike a primary battery that may not be charged. A low-capacity rechargeable battery in which one electrode assembly is packaged in a pack form is used in portable small electronic devices such as a mobile phone or a camcorder. A large-capacity rechargeable battery in which dozens of electrode assemblies are connected is widely used as a power source for driving a motor of an electric scooter, a hybrid vehicle, an electric vehicle, or the like.

Rechargeable batteries are manufactured in various shapes. A pouch rechargeable battery includes an electrode assembly formed by interposing a separator that is an insulator between a positive electrode plate and a negative electrode plate, and a thin flexible pouch in which the electrode assembly is embedded. The pouch accommodates the electrode assembly in an inner space. A plurality of positive electrode tabs are connected to the positive plate of the electrode assembly, and a plurality of negative electrode tabs are connected to the negative electrode plate.

### SUMMARY

The present disclosure overcomes the problems described herein, and an object of the present disclosure is to provide an electrode assembly with improved durability and a rechargeable battery including the same.

An electrode assembly according to the present disclosure includes a first electrode plate and a second electrode plate, each of the first electrode plate and the second electrode plate comprising an electrode current collector and an electrode substrate tab extending externally from a portion of the electrode current collector; a separator interposed between the first electrode plate and the second electrode plate; and a reinforcing member interposed between the separator and an outermost electrode plate disposed at an outermost position of the electrode assembly, the outermost electrode plate being the first electrode plate or the second electrode plate, wherein the reinforcing member is disposed to correspond to an edge portion of the electrode current collector and the electrode substrate tab of the outermost electrode plate.

The reinforcing member may be attached to a surface of the outermost electrode plate facing the separator.

The reinforcing member may be attached to the separator between the outermost electrode plate and the other of the first electrode plate or the second electrode plate.

The first electrode plate may include a first electrode current collector and a first electrode substrate tab extending externally from a portion of the first electrode current collector, and the second electrode plate may include a second electrode current collector and a second electrode substrate tab extending externally from a portion of the second electrode current collector.

The separator may have a relatively greater size than each of a size of the first electrode current collector and a size of the second electrode current collector.

The first electrode current collector and the second electrode current collector may have a same size.

The reinforcing member may be disposed in an inner region of the separator.

A width of a portion of the reinforcing member that extends beyond the electrode current collector in a width direction may be within a range of 0.5 mm to 1.5 mm.

The reinforcing member may extend parallel to a width direction of the electrode substrate tab.

A distance between one end of the reinforcing member and one side end of the electrode substrate tab may be within a range of 1.0 mm to 3.0 mm.

A width of a portion of the reinforcing member that overlaps the electrode current collector in a width direction may be within a range of 0.5 mm to 2.0 mm.

The reinforcing member may comprise a thin film having an adhesive layer formed on one surface thereof.

A rechargeable battery according to the present disclosure includes: the electrode assembly; and a case that accommodates the electrode assembly.

According to some embodiments, there is provided a method of manufacturing an electrode assembly, the method comprising providing a first electrode plate and a second electrode plate, each of the first electrode plate and the second electrode plate comprising an electrode current collector and an electrode substrate tab extending externally from a portion of the electrode current collector; interposing a separating between the first electrode plate and the second electrode plate; and interposing a reinforcing member between the separator and an outermost electrode plate disposed at an outermost position of the electrode assembly, the outermost electrode plate being the first electrode plate or the second electrode plate, wherein the reinforcing member is disposed to correspond to an edge portion of the electrode current collector and the electrode substrate tab of the outermost electrode plate.

In some embodiments, interposing the reinforcing member comprises attaching the reinforcing member to a surface of the outermost electrode plate facing the separator.

In some embodiments, interposing the reinforcing member comprises attaching the reinforcing member to the separator disposed between the outermost electrode plate and the other of the first electrode plate or the second electrode plate.

In some embodiments, the first electrode plate includes a first electrode current collector and a first electrode substrate tab extending externally from a portion of the first electrode current collector, and the second electrode plate includes a second electrode current collector and a second electrode substrate tab extending externally from a portion of the second electrode current collector; and the separator has a relatively greater size than each of a size of the first electrode current collector and a size of the second electrode current collector.

In some embodiments, the first electrode current collector and the second electrode current collector have a same size.

In some embodiments, interposing the reinforcing member comprises disposing the reinforcing member in an inner region of the separator.

In some embodiments, the reinforcing member comprises a thin film having an adhesive layer formed on one surface thereof.

A reinforcing member included in an electrode assembly according to the present disclosure may be disposed to correspond to an edge portion of an electrode current collector and an electrode substrate tab. Therefore, even if swelling occurs in a rechargeable battery, the reinforcing member may disperse a stress generated at the edge portion of the electrode current collector and the electrode substrate tab so that it prevents a damage to the electrode assembly to improve durability.

### BRIEF DESCRIPTION OF THE DRAWINGS

FIG. 1 is a perspective view showing a state in which an electrode assembly according to embodiments of the present disclosure is accommodated in a case.

FIG. 2 is a perspective view showing only the electrode assembly of FIG. 1 having been extracted from the case.

FIG. 3 is an exploded perspective view showing the electrode assembly of FIG. 1.

FIG. 4 is a perspective view showing a state in which the remaining portions of the electrode assembly of FIG. 1 excluding a first electrode plate disposed at an outermost position in FIG. 3 are stacked.

FIG. 5 is a plan view of a state in which a reinforcing member is attached to the first electrode plate disposed at an outermost position in FIG. 4 viewed from an A direction.

FIG. 6 is an exploded perspective view showing an electrode assembly according to other embodiments of the present disclosure.

FIG. 7 is a perspective view showing a state in which the remaining portions of the electrode assembly of FIG. 6 excluding a first electrode plate disposed at an outermost position in FIG. 6 are stacked.

FIG. 8 is a plan view of a state in which a reinforcing member is attached to a separator in FIG. 7 viewed from a B direction.

### DETAILED DESCRIPTION

Embodiments of the present disclosure are provided to more fully describe the present disclosure to a person skilled in the art, the following embodiments may be modified into various different forms, and a scope of the present disclosure is not limited to the following embodiments. The embodiments are provided to make the present disclosure more faithful and complete and to fully convey an idea of the present disclosure to a person skilled in the art.

In the drawings, a thickness or a size of each layer is exaggerated for convenience and clarity of description, and the same reference numeral in the drawings refers to the same element. As used in the present specification, the term “and/or” includes any one of the listed items and all combinations of one or more of the listed items. In addition, in the present specification, “connection” means not only a case where an A member and a B member are directly connected, but also a case where a C member is interposed between the A member and the B member to indirectly connect the A member and the B member.

The terminology used herein is used to describe a specific embodiment, and is not intended to limit the present disclosure. As used herein, a singular form may include a plural form unless the context clearly indicates otherwise. Moreover, as used herein, “comprise, include”, and/or “comprising, including” refer to specify presences of referred shapes, numbers, steps, actions, members, elements, and/or groups thereof, and does not exclude the presence or additions of one or more other shapes, numbers, actions, members, elements, and/or groups.

In the present specification, terms such as first and second are used to describe various members, parts, regions, layers, and/or portions. However, these members, parts, regions, layers, and/or portions should not be limited by these terms. These terms are only used to distinguish one member, part, region, layer, or portion from other members, parts, regions, layers, or portions. Accordingly, the first member, part, region, layer, or portion described below may refer to a second member, part, region, layer, or portion without departing from the teachings of present disclosure.

Terms related to space such as “beneath”, “below”, “lower”, “above”, and “upper” may be used so that one element or feature illustrated in the drawings is easily understood from other elements or features. The terms related to these spaces are for easy understanding of the present disclosure according to various process conditions or use conditions of the present disclosure, and are not intended to limit the present disclosure. For example, if an element or feature in the drawings is inverted, the element or feature described as “bottom” or “below” will be described as “top” or “above”. Accordingly, “below” is a concept including “top” or “bottom”.

Hereinafter, a rechargeable battery including an electrode assembly according to embodiments of the present disclosure will be described in detail before describing the electrode assembly with reference to the accompanying drawings.

For an electrode assembly comprising a plurality of positive and negative electrode tabs, the plurality of positive electrode tabs are formed with the same width and are disposed side by side in a vertical direction, and the plurality of negative electrode tabs are also generally formed in the same manner as the plurality of positive electrode tabs. Therefore, if swelling occurs in the rechargeable battery, there is a problem in which a fracture occurs when a stress acts on an edge portion of the positive electrode tab and a substrate. Aspects of the technology described herein provide a solution for the above-described problem.

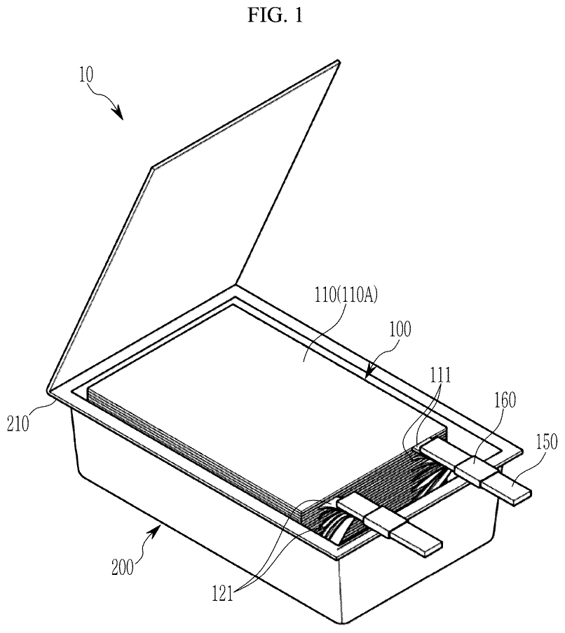

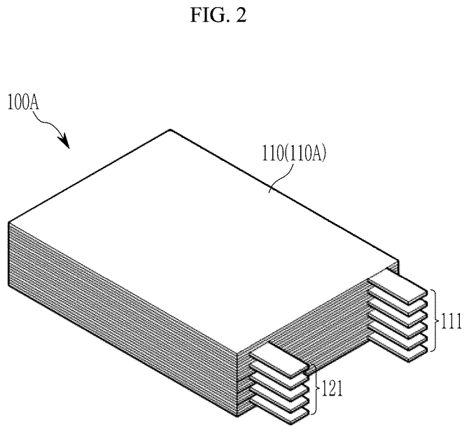

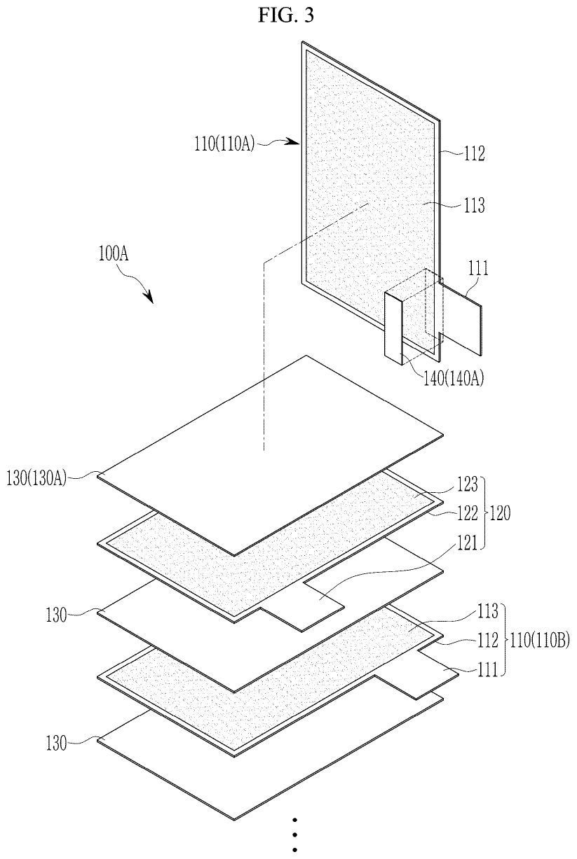

FIG. 1 is a perspective view showing a state in which the electrode assembly according to embodiments of the present disclosure is accommodated in a case, FIG. 2 is a perspective view showing only the electrode assembly of FIG. 1 extracted from the case, and FIG. 3 is an exploded perspective view showing the electrode assembly of FIG. 1.

As shown in FIGS. 1 to 3, the rechargeable battery 10 may include the electrode assembly 100 and the case 200.

The electrode assembly 100 may include a first electrode plate 110, a second electrode plate 120, and a separator 130. The electrode assembly 100 may have a form in which a laminate including the first electrode plate 110, the second electrode plate 120, and the separator 130 is repeatedly wound or stacked.

For example, the electrode assembly 100 may have a jelly-roll type that is repeatedly wound. Alternatively, there may be a plurality of electrode assemblies 100, and the plurality of electrode assemblies 100 may be a stacked type disposed to be stacked in a plurality of layers. In the present disclosure, the electrode assembly 100 having the stacked type will be described as an example.

Each of the first electrode plate 110 and the second electrode plate 120 may include an electrode current collector and an electrode substrate tab extending externally from a portion of the electrode current collector.

For example, in the illustrated embodiment, the first electrode plate 110 may include a first electrode current collector 112 and a first electrode substrate tab 111 extending externally from a portion of the first electrode current collector 112. There may be a plurality of first electrode plates 110, and a corresponding plurality of first electrode substrate tabs 111 may be coupled to each other by a welding method. For example, the plurality of first electrode substrate tabs 111 may be collected to be coupled by the welding method such as laser welding, resistance welding, or ultrasonic welding.

The second electrode plate 120 may include a second electrode current collector 122 and a second electrode substrate tab 121 extending externally from a portion of the second electrode current collector 122. If the electrode assembly 100 is a stacked type, the first electrode plate 110 and the second electrode plate 120 may be alternately stacked.

For example, like the first electrode plate 110, there may be a plurality of second electrode plates 120, and there may be a corresponding plurality of second electrode substrate tabs 121. The plurality of second electrode substrate tabs 121 may be coupled to each other by the welding method described with respect to the first electrode substrate tab 111, but may be coupled to each other by an adhesive material.

In some embodiments, the second electrode plate 120 may be a negative electrode and the first electrode plate 110 may be a positive electrode, or vice versa. The first electrode plate 110 and the second electrode plate 120 may be electrically connected to the outside of the rechargeable battery 10 through a strip terminal (not shown). Hereinafter, for convenience of description, it will be described as an example that the first electrode plate 110 is a positive electrode and the second electrode plate 120 is a negative electrode.

For example, the first electrode plate 110 that is the positive electrode may be formed by applying a first electrode active material 113 such as transition metal oxide or the like to the first electrode current collector 112 formed of a metal foil such as aluminum or an aluminum alloy. The first electrode substrate tab 111 may be integrally formed with the first electrode current collector 112, and as described above, may extend from a portion of the first electrode plate 110 to the outside of the electrode assembly 100.

As an example, the first electrode plate 110 may be manufactured by pressing the first electrode current collector 112 with a press to leave a predetermined shape and generating the first electrode substrate tab 111 using the predetermined shape. As an example, the first electrode substrate tab 111 may have a rectangular shape.

In some embodiments, the first electrode substrate tab 111 may be disposed so as not to overlap the second electrode substrate tab 121. For example, all of the substrate tabs disposed at a right side of a direction shown in FIG. 2 may be the first electrode substrate tabs 111.

The first electrode substrate tabs 111 may be disposed to be spaced apart from the second electrode substrate tabs 121. Because the electrode assembly 100 may comprise a plurality of first electrode substrate tabs 111, the first electrode substrate tabs 111 may also be defined as multi-tabs. The first electrode substrate tab 111 may be a path for a current flow between the first electrode current collector 112 and a strip terminal (not shown).

The second electrode plate 120 that is the negative electrode may be formed by applying the second electrode active material 123 such as graphite, carbon, or the like to the second electrode current collector 122 formed of a metal foil such as copper, a copper alloy, nickel, or a nickel alloy. The second electrode substrate tab 121 may be integrally formed with the second electrode current collector 122, and as described above, the second electrode substrate tab 121 may extend to the outside of the second electrode current collector 122.

As an example, the second electrode plate 120 may be manufactured by pressing the second electrode current collector 122 with a press to leave a predetermined shape and generating the second electrode substrate tab 121 using the predetermined shape. As an example, the second electrode substrate tab 121 may have a rectangular shape.

The separator 130 may be interposed between the first electrode plate 110 and the second electrode plate 120. The separator 130 may prevent a short circuit between the first electrode plate 110 and the second electrode plate 120, and may allow a movement of a lithium ion. To this end, the separator 130 may have a relatively larger size than that of the first electrode current collector 112 and the second electrode current collector 122. The first electrode current collector 112 and the second electrode current collector 122 described herein may have the same size.

For example, a material of the separator 130 may be polyethylene, polypropylene, or a composite film of polyethylene and polypropylene, but the present disclosure is not limited thereto.

The separator 130 may be cut into a unit length to be disposed between the first electrode plate 110 and the second electrode plate 120, or the separator 130 having a ribbon shape may be disposed in a zigzag shape between the first electrode plate 110 and the second electrode plate 120. Alternatively, the separator 130 may be installed to be wound in one direction between the first electrode plate 110 and the second electrode plate 120. Although a disposition form of the separator 130 is not limited to a specific form, in the present embodiment, it will be described that the separator 130 is cut into the unit length to be disposed between the first electrode plate 110 and the second electrode plate 120.

The case 200 may accommodate the electrode assembly 100. The electrode assembly 100 described above may be accommodated in the case 200 together with an electrolyte. In some embodiments, an insulating tape may be installed at a portion of a strip terminal. The insulating tape may prevent the strip terminal and the case from being energized.

The case 200 as described above may be one of a pouch type, a cylindrical type, and/or a prismatic type. The pouch type case 200 may be manufactured by bending an exterior material with a plate shape to face each other, pressing or drawing one surface, and including a recess on the one surface.

The electrode assembly 100 may be accommodated in the recess (not shown). A sealing portion 210 may be formed at an outer circumference of the recess, and the sealing portion 210 may be sealed by a method such as heat staking (or thermal fusion) or the like in a state where the electrode assembly 100 is accommodated in the recess.

In some embodiments, a manufacturing process of the electrode assembly 100 described above may include a primary stacking step and a secondary stacking step.

In the first stacking step, a full cathode that is referred to as the remainder of the first electrode plate 110 except for an initial first electrode plate 110A disposed at an outermost position of the electrode assembly and a full positive electrode that is the second electrode plate 120, may be sequentially stacked.

In the secondary stacking step, a half cathode may be stacked at one or more of both outermost sides of the electrode assembly with reference to a stacking direction. For example, the half cathode may be the initial first electrode plate 110A disposed at the outermost position among the first electrode plates 110. For convenience of description, the drawings illustrate that the electrode assembly 100 in which the half cathode is stacked at both upper and lower outermost sides of the electrode assembly 100. However, the half cathode may be stacked only at the upper outermost side of the electrode assembly 100, and a half positive electrode may be stacked at the lower outermost side of the electrode assembly 100.

For example, the full cathode and the full positive electrode may be formed by applying an active material to both surfaces of a substrate, and the half cathode may be formed by applying an active material to only one surface of the substrate. A detailed description of the full cathode, the full positive electrode, and the half cathode will be omitted.

Hereinafter, the electrode assembly according to embodiments of the present disclosure will be described in more detail with reference to the drawings.

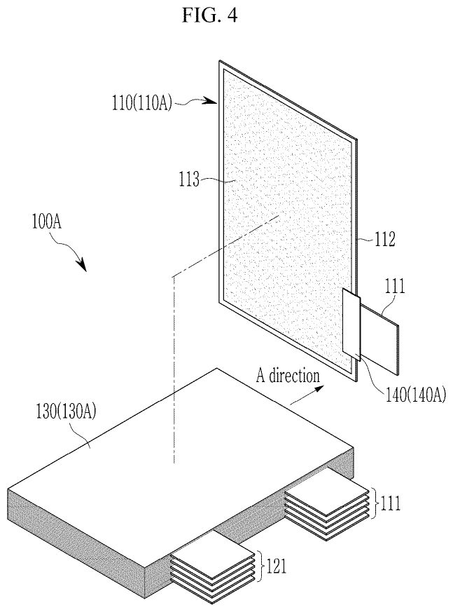

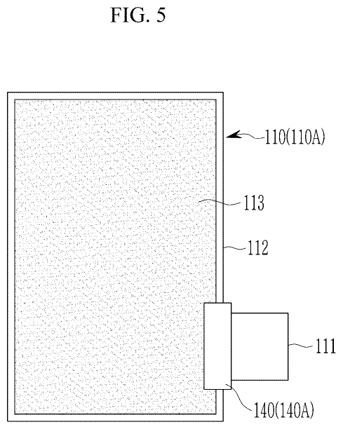

FIG. 3 is an exploded perspective view showing the electrode assembly of FIG. 1, FIG. 4 is a perspective view showing a state in which the remaining portions of the electrode assembly excluding a first electrode plate disposed at an outermost position in FIG. 3 are stacked, and FIG. 5 is a plan view of a state in which a reinforcing member is attached to the first electrode plate disposed at an outermost position in FIG. 4 viewed from an A direction.

Referring to FIGS. 3 to 5, the electrode assembly 100 according to embodiments of the present disclosure may include the first electrode plate 110, the second electrode plate 120, the separator 130, and the reinforcing member 140. Because the first electrode plate 110, the second electrode plate 120, and the separator 130 are described above, a detailed description thereof will be omitted.

The reinforcing member 140 may be interposed between the separator 130 and any one of the first electrode plate 110 and the second electrode plate 120 disposed at an outermost position, and may be disposed to correspond to edge portions of the electrode current collector and the electrode substrate tab.

The reinforcing member 140 may have a ribbon shape. This reinforcing member 140 may be disposed parallel to a width direction of the electrode substrate tab 111, as shown in FIG. 3. The reinforcing member 140 may be attached to one of the first electrode plate 110 and/or the second electrode plate 120 disposed at the outermost position or may be attached to the separator 130 disposed at an outermost position in the electrode assembly 100. A description thereof will be described in detail with reference to the drawings.

The reinforcing member 140 may be attached to a surface facing the separator 130 at any one of the first electrode plate 110 and the second electrode plate 120 disposed at the outermost position. For example, the reinforcing member 140 may be a thin film having an adhesive layer formed on one surface thereof. Thus, the reinforcing member 140 may be attached to the first electrode plate 110 or the second electrode plate 120 by an adhesive method, so that a manufacturing process may be carried out quickly.

The reinforcing member 140 may be disposed to correspond to the edge portion of the electrode current collector and the electrode substrate tab. Thus, even if swelling occurs in the rechargeable battery 10, the reinforcing member 140 may disperse a stress generated at the edge portion of the electrode current collector and the electrode substrate tab so that it prevents a damage to the electrode assembly 100 to improve durability.

Alternatively, the reinforcing member 140 may be attached to the separator 130.

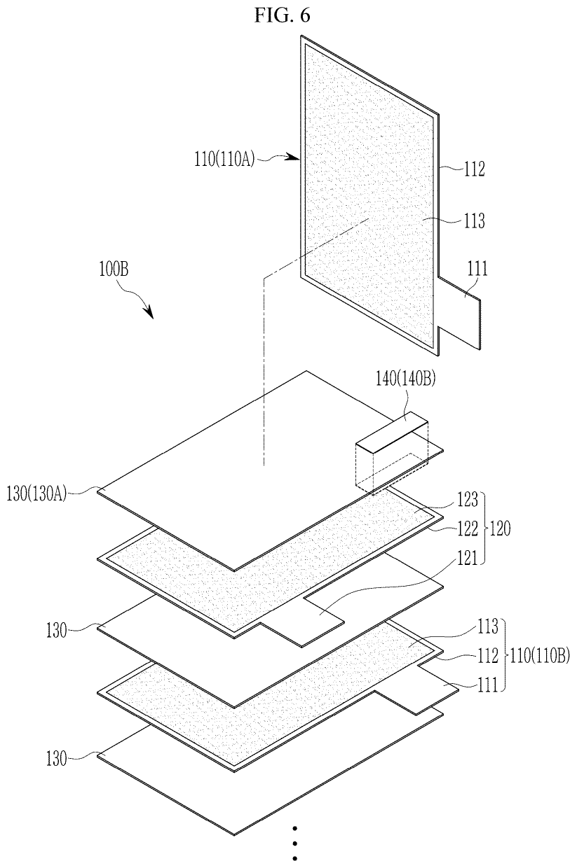

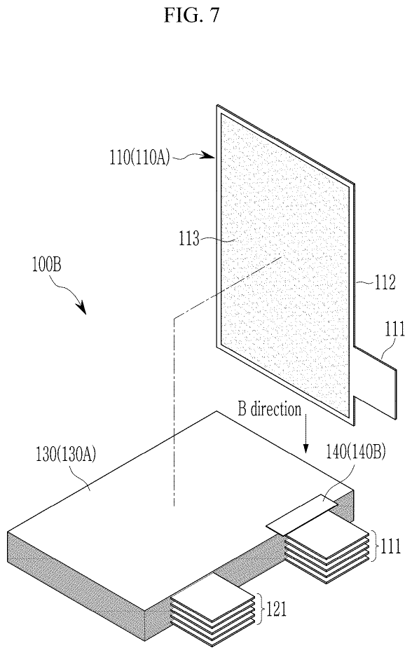

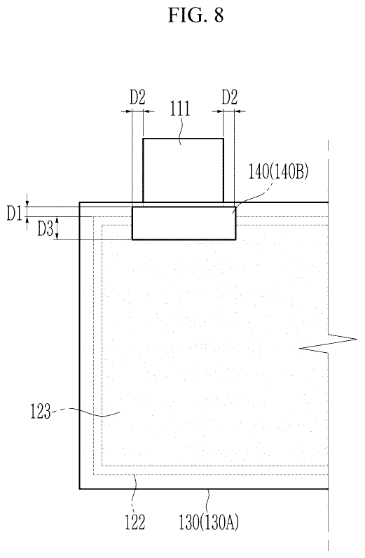

FIG. 6 is an exploded perspective view showing an electrode assembly according to other embodiments of the present disclosure, FIG. 7 is a perspective view showing a state in which the remaining portions of the electrode assembly of FIG. 6 excluding a first electrode plate disposed at an outermost position in FIG. 6 are stacked, and FIG. 8 is a plan view of a state in which a reinforcing member is attached to a separator in FIG. 7 viewed from a B direction.

Referring to FIGS. 6 to 8, in the electrode assembly 100 according to other embodiments of the present disclosure, the reinforcing member 140 may be attached to an outermost separator 130A.

As described above, the separator 130 may be disposed between the first electrode plate 110 and the second electrode plate 120. If the first electrode plate 110A is disposed at the outermost position in the electrode assembly 100, the outermost separator 130A among a plurality of separators 130 may be disposed between the outermost first electrode plate 110A and the second electrode plate 120 adjacent thereto. For example, the reinforcing member 140 may be attached to the outermost separator 130A, and may be disposed to correspond to an edge portion of the first electrode current collector 112 and the first electrode substrate tab 111.

Thus, the reinforcing member 140 may improve a resistance of the first electrode current collector 112 and the first electrode substrate tab 111 to an external force. Therefore, even if swelling occurs in the rechargeable battery 10, the reinforcing member 140 may disperse a stress generated at the edge portion of the first electrode current collector 112 and the first electrode substrate tab 111 so that damage to the electrode assembly 100 is prevented to improve durability.

Although it is described that the first electrode plate 110 is disposed at the outermost position in the electrode assembly 100 for convenience of description, the second electrode plate 120 may be disposed at an outermost position in the electrode assembly 100.

As described above, the reinforcing member 140 may be interposed between the separator 130 and the electrode plate disposed at an outermost side in most electrode assemblies 100 regardless of a structure of the electrode assembly 100. For example, the first electrode plate 110 may be disposed at outermost positions of both upper and lower sides of the electrode assembly 100. Conversely, the second electrode plates 120 may be disposed at the outermost positions of both upper and lower sides of the electrode assembly 100.

In some embodiments, the first electrode plate 110 may be disposed at the upper outermost side of the electrode assembly 100, and the second electrode plate 120 may be disposed at the lower outermost side of the electrode assembly 100. Conversely, the second electrode plate 120 may be disposed at the upper outermost side of the electrode assembly 100, and the first electrode plate 110 may be disposed at the lower outermost side of the electrode assembly 100.

The reinforcing member 140 may be interposed between the separator 130 and the electrode plate disposed at the outermost position in various electrode assemblies 100.

In some embodiments, the reinforcing member 140 as described above may be disposed in an inner region of the separator 130. If the reinforcing member 140 is disposed to extend to the outside with respect to the separator 130, the reinforcing member 140 may be damaged by contact with a peripheral member inside the rechargeable battery 10.

FIG. 8 is the plan view of the state in which the reinforcing member is attached to the separator in FIG. 7 viewed from the B direction

Referring to a position of the reinforcing member 140 described above with reference to FIG. 8 described in more detail, a distance (or a length) D1 of a portion of the reinforcing member 140 that extends to the outside with respect to the electrode current collector 122 in a width direction may be included in a range of 0.5 mm to 1.5 mm. For example, a distance D2 between one end of the reinforcing member 140 and one side end of the electrode substrate tab 111 may be included in a range of 1.0 mm to 3.0 mm.

In some embodiments, a distance D3 of a portion of the reinforcing member 140 that overlaps the electrode current collector 122 in the width direction may be included in a range of 0.5 mm to 2.0 mm. For example, by setting the position of the reinforcing member 140 to the above-described value, the reinforcing member 140 may stably absorb a stress generated at an edge portion of the electrode current collector and the electrode substrate tab.

According to some embodiments, there is provided a method of manufacturing an electrode assembly, the method comprising providing a first electrode plate and a second electrode plate, each of the first electrode plate and the second electrode plate comprising an electrode current collector and an electrode substrate tab extending externally from a portion of the electrode current collector; interposing a separating between the first electrode plate and the second electrode plate; and interposing a reinforcing member between the separator and an outermost electrode plate disposed at an outermost position of the electrode assembly, the outermost electrode plate being the first electrode plate or the second electrode plate, wherein the reinforcing member is disposed to correspond to an edge portion of the electrode current collector and the electrode substrate tab of the outermost electrode plate.

In some embodiments, interposing the reinforcing member comprises attaching the reinforcing member to a surface of the outermost electrode plate facing the separator.

In some embodiments, interposing the reinforcing member comprises attaching the reinforcing member to the separator disposed between the outermost electrode plate and the other of the first electrode plate or the second electrode plate.

In some embodiments, the first electrode plate includes a first electrode current collector and a first electrode substrate tab extending externally from a portion of the first electrode current collector, and the second electrode plate includes a second electrode current collector and a second electrode substrate tab extending externally from a portion of the second electrode current collector; and the separator has a relatively greater size than each of a size of the first electrode current collector and a size of the second electrode current collector.

In some embodiments, the first electrode current collector and the second electrode current collector have a same size.

In some embodiments, interposing the reinforcing member comprises disposing the reinforcing member in an inner region of the separator.

In some embodiments, the reinforcing member comprises a thin film having an adhesive layer formed on one surface thereof.

Although various embodiments of the present disclosure have been described, the drawings and the detailed description that are described above are merely illustrative, are used only for a purpose of describing the present disclosure, and are not used for limiting a meaning or a scope of the present disclosure disclosed in the claims. Therefore, a person skilled in the art will understand that various modifications and other equivalent embodiments may be derived therefrom. Thus, a true technical protection scope of the present disclosure should be determined by a technical idea of the appended claims.

### DESCRIPTION OF SYMBOLS

10: rechargeable battery 100: electrode assembly 110: first electrode plate 111: first electrode substrate tab 112: first electrode current collector 113: first electrode active material 120: second electrode plate 121: second electrode substrate tab 122: second electrode current collector 123: second electrode active material 130: separator 140: reinforcing member 200: case

What is claimed is:

1. An electrode assembly comprising:
a first electrode plate and a second electrode plate, each of the first electrode plate and the second electrode plate comprising an electrode current collector and an electrode substrate tab extending externally from a portion of the electrode current collector;
a separator interposed between the first electrode plate and the second electrode plate; and
a reinforcing member interposed between the separator and an outermost electrode plate disposed at an outermost position of the electrode assembly, the outermost electrode plate being the first electrode plate or the second electrode plate, wherein the reinforcing member is disposed to correspond to an edge portion of the electrode current collector and the electrode substrate tab of the outermost electrode plate.

2. The electrode assembly as claimed in claim 1, wherein the reinforcing member is attached to a surface of the outermost electrode plate facing the separator.

3. The electrode assembly as claimed in claim 1, wherein the reinforcing member is attached to the separator disposed between the outermost electrode plate and the other of the first electrode plate or the second electrode plate.

4. The electrode assembly as claimed in claim 1, wherein the first electrode plate includes a first electrode current collector and a first electrode substrate tab extending externally from a portion of the first electrode current collector, and the second electrode plate includes a second electrode current collector and a second electrode substrate tab extending externally from a portion of the second electrode current collector.

5. The electrode assembly as claimed in claim 4, wherein the separator has a relatively greater size than each of a size of the first electrode current collector and a size of the second electrode current collector.

6. The electrode assembly as claimed in claim 4, wherein the first electrode current collector and the second electrode current collector have a same size.

7. The electrode assembly as claimed in claim 1, wherein the reinforcing member is disposed in an inner region of the separator.

8. The electrode assembly as claimed in claim 1, wherein a width of a portion of the reinforcing member that extends beyond the electrode current collector in a width direction is within a range of 0.5 mm to 1.5 mm.

9. The electrode assembly as claimed in claim 1, wherein the reinforcing member extends parallel to a width direction of the electrode substrate tab.

10. The electrode assembly as claimed in claim 1, wherein a distance between one end of the reinforcing member and one side end of the electrode substrate tab is within a range of 1.0 mm to 3.0 mm.

11. The electrode assembly as claimed in claim 1, wherein a width of a portion of the reinforcing member that overlaps the electrode current collector in a width direction is within a range of 0.5 mm to 2.0 mm.

12. The electrode assembly as claimed in claim 1, wherein the reinforcing member comprises a thin film having an adhesive layer formed on one surface thereof.

13. A rechargeable battery comprising:
the electrode assembly according to claim 1; and
a case that accommodates the electrode assembly.
